(19) United States
(12) Patent Application Publication
(10) Pub. No.: US 2023/0147734 A1
(43) Pub. Date: May 11, 2023

(54) COMMUNICATION METHOD AND APPARATUS

(71) Applicant: HUAWEI TECHNOLOGIES CO., LTD., Shenzhen (CN)

(72) Inventors: Ran SANG, Nanjing (CN); Chenhe JI, Nanjing (CN); Yungui WANG, Nanjing (CN); Xingfeng JIANG, Nanjing (CN); Chun PAN, Nanjing (CN)

(73) Assignee: HUAWEI TECHNOLOGIES CO., LTD., Shenzhen (CN)

(21) Appl. No.: 18/153,494

(22) Filed: Jan. 12, 2023

Related U.S. Application Data
(63) Continuation of application No. PCT/CN2021/105575, filed on Jul. 9, 2021.

(30) Foreign Application Priority Data
Jul. 13, 2020 (CN) 202010670917.8

(51) Int. Cl. H04W 76/20; H04W 28/02; H04W 72/20

(52) U.S. Cl. CPC H04W 76/20; H04W 28/0278; H04W 72/20

(57) ABSTRACT

Embodiments of this application disclose a second multi-link device that receives a first message from a first multi-link device, and determines, based on the first message, to send data to the first multi-link device in a duplication transmission mode or a non-duplication transmission mode. The first message indicates transmission modes for the second multi-link device to send different types of data, and the transmission modes include the duplication transmission mode and the non-duplication transmission mode.

### CROSS-REFERENCE TO RELATED APPLICATIONS

This application is a continuation of International Application No. PCT/CN2021/105575, filed on Jul. 9, 2021, which claims priority to Chinese Patent Application No. 202010670917.8, filed on Jul. 13, 2020. The disclosures of the aforementioned applications are herein incorporated by reference in their entireties.

### TECHNICAL FIELD

This application generally relates to the communication field, and in particular, to a communication method and apparatus.

### BACKGROUND

A multi-link transmission technology can improve data transmission reliability and a transmission rate. For example, a first multi-link device may communicate with a second multi-link device over multiple links (for example, a link 1 and a link 3), and the first multi-link device may further communicate with a third multi-link device over multiple links (for example, a link 2 and the link 3). If the same data is transmitted over multiple links, reliability of data transmission can be improved. If different data is transmitted over multiple links, a rate of data transmission can be improved.

However in the same example, the first multi-link device may communicate with the second multi-link device over the link 1 and the link 3. If the same data is transmitted over the link 1 and the link 3, reliability of data transmission can be ensured. However, a resource of the link 3 is occupied, which may affect communication between the third multi-link device and the first multi-link device over the link 3, and reduce a transmission rate of data transmission between the third multi-link device and the first multi-link device. If different data is transmitted over the link 1 and the link 3, a rate of data transmission between the second multi-link device and the first multi-link device and a rate of data transmission between the third multi-link device and the first multi-link device can be improved, but a reliability of data transmission between the second multi-link device and the first multi-link device may be reduced.

In other words, in the conventional technology, when multiple links are used for communication between multi-link devices, both reliability and a transmission rate of data transmission cannot be ensured.

### SUMMARY

Embodiments of this application provide a communication method and an apparatus, to resolve a problem that multiple links cannot be effectively used for communication between multi-link devices, and improve data transmission efficiency while ensuring data transmission reliability.

To achieve the foregoing objective, this application uses the following technical solutions.

According to a first aspect, a communication method is provided. The communication method includes: A second multi-link device receives a first message from a first multi-link device, and determines, based on the first message, to send data to the first multi-link device in a duplication transmission mode or a non-duplication transmission mode. The first message indicates transmission modes for a second multi-link device to send different types of data, and the transmission modes include the duplication transmission mode and the non-duplication transmission mode.

According to the communication method in the first aspect, the second multi-link device determines, based on the first message that is sent by the first multi-link device and that indicates the transmission modes for the second multi-link device to send different types of data, to send the data to the first multi-link device in the duplication transmission mode or the non-duplication transmission mode. In this way, the different types of data can be transmitted in corresponding transmission modes, and multiple links between the first multi-link device and the second multi-link device are properly used, to improve data transmission efficiency while ensuring reliability.

In a possible design solution, the communication method according to the first aspect may further include: The second multi-link device sends a second message to the first multi-link device. The second message may be determined based on the first message, and the second message may indicate transmission modes for the second multi-link device to send different types of data. In other words, the second multi-link device may negotiate with the first multi-link device to determine the transmission modes for the second multi-link device to send the different types of data.

In a possible design solution, the first message may include transmission mode information of at least one piece of traffic identifier (TID) type data.

In a possible design solution, the first message may include transmission mode information of at least one piece of TID type data corresponding to at least one link.

In a possible design solution, the first message may include transmission mode information of at least one piece of traffic stream (TS) type data.

In a possible design solution, in a possible design solution, the first message may include transmission mode information of at least one piece of TS type data corresponding to at least one link.

In a possible design solution, the first message may include one or more of a transmission delay threshold, a transmission packet loss rate threshold, or a buffer size threshold of at least one piece of TID type data.

In a possible design, the first message may include one or more of a transmission delay threshold, a transmission packet loss rate threshold, or a buffer size threshold of at least one piece of TID type data corresponding to at least one link.

In a possible design, the first message may include one or more of a transmission delay threshold, a transmission packet loss rate threshold, or a buffer size threshold of at least one piece of TS type data.

In a possible design solution, the first message may include one or more of a transmission delay threshold, a transmission packet loss rate threshold, or a buffer size threshold of at least one piece of TS type data corresponding to at least one link.

Optionally, the first message may include at least one second multi-link device identifier.

In a possible design solution, that a second multi-link device determines, based on the first message, to send data to the first multi-link device in a duplication transmission mode or a non-duplication transmission mode may include: If a first condition is met, the second multi-link device determines to send data to the first multi-link device in the duplication transmission mode, where the first condition may include: a transmission delay of the TID type data is greater than the transmission delay threshold of the TID type data, or a transmission packet loss rate of the TID type data is greater than the transmission packet loss rate threshold of the TID type data, or a buffer size of the TID type data is greater than the buffer size threshold of the TID type data.

In a possible design solution, that a second multi-link device determines, based on the first message, to send data to the first multi-link device in a duplication transmission mode or a non-duplication transmission mode may include: If a second condition is met, the second multi-link device determines to send data to the first multi-link device in the duplication transmission mode, where the second condition may include: a transmission delay of the type data corresponding to the link is greater than the transmission delay threshold of the TID type data corresponding to the link, or a transmission packet loss rate of the TID type data corresponding to the link is greater than the transmission packet loss rate threshold of the TID type data corresponding to the link, or a buffer size of the TID type data corresponding to the link is greater than the buffer size threshold of the TID type data corresponding to the link.

In a possible design solution, that a second multi-link device determines, based on the first message, to send data to the first multi-link device in a duplication transmission mode or a non-duplication transmission mode may include: If a third condition is met, the second multi-link device determines to send data to the first multi-link device in the duplication transmission mode, where the third condition includes: a transmission delay of the TS type data is greater than the transmission delay threshold of the TS type data, or a transmission packet loss rate of the TS type data is greater than the transmission packet loss rate threshold of the TS type data, or a buffer size of the TS type data is greater than the buffer size threshold of the TS type data.

In a possible design solution, that a second multi-link device determines, based on the first message, to send data to the first multi-link device in a duplication transmission mode or a non-duplication transmission mode may include: If a fourth condition is met, the second multi-link device determines to send data to the first multi-link device in the duplication transmission mode, where the fourth condition may include: a transmission delay of the TS type data corresponding to the link is greater than the transmission delay threshold of the TS type data corresponding to the link, or a transmission packet loss rate of the TS type data corresponding to the link is greater than the transmission packet loss rate threshold of the TS type data corresponding to the link, or a buffer size of the TS type data corresponding to the link is greater than the buffer size threshold of the TS type data corresponding to the link.

Optionally, the duplication transmission mode may be transmitting same data over at least two links. The duplication transmission mode may include a synchronous duplication transmission mode and an asynchronous duplication transmission mode. The synchronous duplication transmission mode may be simultaneously transmitting same data over the at least two links. The asynchronous duplication transmission mode may be transmitting same data over the at least two links at different times.

Optionally, the non-duplication transmission may be transmitting different data over a first link and a second link. The non-duplication transmission mode may include a synchronous non-duplication transmission mode and an asynchronous non-duplication transmission mode. The synchronous non-duplication transmission mode may be simultaneously transmitting different data over the first link and the second link. The asynchronous non-duplication transmission mode may be transmitting different data over the first link and the second link at different times, the second link is a link other than the first link between the first multi-link device and the second multi-link device.

According to a second aspect, a communication method is provided. The communication method includes: A first multi-link device generates a first message, and sends the first message to a second multi-link device. The first message indicates transmission modes for the second multi-link device to send different types of data, and the transmission modes include a duplication transmission mode and a non-duplication transmission mode.

In a possible design solution, the communication method according to the second aspect may further include: The first multi-link device receives a second message from the second multi-link device, where the second message may be determined based on the first message, and the second message may indicate transmission modes for the second multi-link device to send different types of data.

In a possible design solution, the first message may include transmission mode information of at least one piece of TID type data.

In a possible design solution, the first message may include transmission mode information of at least one piece of TID type data corresponding to at least one link.

In a possible design solution, the first message may include transmission mode information of at least one piece of TS type data.

In a possible design solution, in a possible design solution, the first message may include transmission mode information of at least one piece of TS type data corresponding to at least one link.

In a possible design solution, the first message may include one or more of a transmission delay threshold, a transmission packet loss rate threshold, or a buffer size threshold of at least one piece of TID type data.

In a possible design, the first message may include one or more of a transmission delay threshold, a transmission packet loss rate threshold, or a buffer size threshold of at least one piece of TID type data corresponding to at least one link.

In a possible design, the first message may include one or more of a transmission delay threshold, a transmission packet loss rate threshold, or a buffer size threshold of at least one piece of TS type data.

In a possible design solution, the first message may include one or more of a transmission delay threshold, a transmission packet loss rate threshold, or a buffer size threshold of at least one piece of TS type data corresponding to at least one link.

Optionally, the first message may include at least one second multi-link device identifier.

In a possible design solution, that the first message indicates transmission modes for the second multi-link device to send different types of data may include: If a first condition is met, the first message indicates to transmit the TID type data in the duplication transmission mode, where the first condition may include: a transmission delay of the TID type data is greater than the transmission delay threshold of the TID type data, or a transmission packet loss rate of the TID type data is greater than the transmission packet loss rate threshold of the TID type data, or a buffer size of the TID type data is greater than the buffer size threshold of the TID type data.

In another possible design solution, that the first message indicates transmission modes for the second multi-link device to send different types of data may include: If a second condition is met, the first message indicates to transmit the TID type data corresponding to the link in the duplication transmission mode, where the second condition may include: a transmission delay of the TID type data corresponding to the link is greater than the transmission delay threshold of the TID type data corresponding to the link, or a transmission packet loss rate of the TID type data corresponding to the link is greater than the transmission packet loss rate threshold of the TID type data corresponding to the link, or a buffer size of the TID type data corresponding to the link is greater than the buffer size threshold of the TID type data corresponding to the link.

In a possible design solution, that the first message indicates transmission modes for the second multi-link device to send different types of data may include: If a third condition is met, the first message indicates to transmit the TS type data in the duplication transmission mode. The third condition may include: a transmission delay of the TS type data is greater than the transmission delay threshold of the TS type data, or a transmission packet loss rate of the TS type data is greater than the transmission packet loss rate threshold of the TS type data, or a buffer size of the TS type data is greater than the buffer size threshold of the TS type data.

In a possible design solution, that the first message indicates transmission modes for the second multi-link device to send different types of data may include: If a fourth condition is met, the first message indicates to transmit the TS type data corresponding to the link in the duplication transmission mode. The fourth condition may include: a transmission delay of the TS type data corresponding to the link is greater than the transmission delay threshold of the TS type data corresponding to the link, or a transmission packet loss rate of the TS type data corresponding to the link is greater than the transmission packet loss rate threshold of the TS type data corresponding to the link, or a buffer size of the TS type data corresponding to the link is greater than the buffer size threshold of the TS type data corresponding to the link.

Optionally, the duplication transmission mode may be transmitting same data over at least two links. The duplication transmission mode may include a synchronous duplication transmission mode and an asynchronous duplication transmission mode. The synchronous duplication transmission mode may be simultaneously transmitting same data over the at least two links. The asynchronous duplication transmission mode may be transmitting same data over the at least two links at different times.

Optionally, the non-duplication transmission may be transmitting different data over a first link and a second link. The non-duplication transmission mode may include a synchronous non-duplication transmission mode and an asynchronous non-duplication transmission mode. The synchronous non-duplication transmission mode may be simultaneously transmitting different data over the first link and the second link. The asynchronous non-duplication transmission mode may be transmitting different data over the first link and the second link at different times, the second link is a link other than the first link between the first multi-link device and the second multi-link device.

In addition, for a technical effect of the communication method in the second aspect, refer to a technical effect of the communication method in any implementation of the first aspect. Details are not described herein again.

According to a third aspect, a communication apparatus is provided. The communication apparatus includes units configured to perform the communication method according to any one of the first aspect or the possible implementations of the first aspect.

In addition, for a technical effect of the communication apparatus according to the third aspect, refer to a technical effect of the communication method in any implementation of the first aspect. Details are not described herein again.

According to a fourth aspect, a communication apparatus is provided. The communication apparatus includes units configured to perform the communication method according to any one of the second aspect or the possible implementations of the second aspect.

In addition, for a technical effect of the communication apparatus according to the fourth aspect, refer to a technical effect of the communication method in any implementation of the second aspect. Details are not described herein again.

According to a fifth aspect, a communication apparatus is provided. The communication apparatus includes a processor, and the processor is coupled to a memory. The memory is configured to store a computer program. The processor is configured to execute the computer program stored in the memory, so that the communication apparatus performs the communication method according to any one of the possible implementations of the first aspect and the second aspect.

According to a sixth aspect, a communication system is provided. The system includes a first multi-link device and one or more second multi-link devices.

According to a seventh aspect, a computer-readable storage medium is provided. The computer-readable storage medium includes a computer program or instructions. When the computer program or the instructions is or are run on a computer, the computer is enabled to perform the method according to any one of the possible implementations of the first aspect and the second aspect.

According to an eighth aspect, a computer program product is provided. The computer program product includes a computer program or instructions. When the computer program or the instructions is or are run on a computer, the computer is enabled to perform the method according to any one of the possible implementations of the first aspect and the second aspect.

### BRIEF DESCRIPTION OF DRAWINGS

FIG. 1 is a schematic diagram of an architecture of a communication system according to an embodiment of this application;

FIG. 2 is a schematic diagram 1 of a structure of an access point (AP) multi-link device and a station (STA) multi-link device according to an embodiment of this application;

FIG. 3 is a schematic diagram 2 of a structure of an AP multi-link device and a STA multi-link device according to an embodiment of this application;

FIG. 4 is a schematic diagram 3 of a structure of an AP multi-link device and a STA multi-link device according to an embodiment of this application;

FIG. 5 is a schematic diagram 1 of a communication scenario of an AP multi-link device and a STA multi-link device according to an embodiment of this application;

FIG. 6 is a schematic diagram 2 of a communication scenario of an AP multi-link device and a STA multi-link device according to an embodiment of this application;

FIG. 7 is a schematic diagram 1 of a structure of a communication apparatus according to an embodiment of this application;

FIG. 8 is a schematic flowchart 1 of a communication method according to an embodiment of this application;

FIG. 9 is a schematic diagram 1 of links according to an embodiment of this application;

FIG. 10 is a schematic diagram 1 of a first message according to an embodiment of this application;

FIG. 11 is a schematic diagram 2 of links according to an embodiment of this application;

FIG. 12 is a schematic diagram 2 of a first message according to an embodiment of this application;

FIG. 13 is a schematic diagram of a synchronous duplication transmission mode according to an embodiment of this application;

FIG. 14 is a schematic diagram of an asynchronous duplication transmission mode according to an embodiment of this application;

FIG. 15 is a schematic diagram of a synchronous non-duplication transmission mode according to an embodiment of this application;

FIG. 16 is a schematic diagram of an asynchronous non-duplication transmission mode according to an embodiment of this application; and

FIG. 17 is a schematic diagram 2 of a structure of a communication apparatus according to an embodiment of this application.

### DESCRIPTION OF EMBODIMENTS

The following describes technical solutions of this application with reference to accompanying drawings.

The technical solutions in embodiments of this application may be applied to various communication systems, for example, a wireless fidelity (Wi-Fi) system, a vehicle to everything (V2X) communication system, a device-to-device (D2D) communication system, an internet of vehicles communication system, 4th generation (4G) mobile communication systems such as a long term evolution (LTE) system and a worldwide interoperability for microwave access (WiMAX) communication system, 5th generation (5G) mobile communication systems such as a new radio (NR) system, and future communication systems such as a 6th generation (6G) mobile communication system.

All aspects, embodiments, or features are presented in this application by describing a system that may include multiple devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

In addition, in embodiments of this application, terms such as “example” and “for example” are used to represent giving an example, an illustration, or a description. Any embodiment or design scheme described as an “example” in this application should not be explained as being more preferred or having more advantages than another embodiment or design scheme. Exactly, the word “example” is used to present a concept in a specific manner.

In embodiments of this application, terms “information”, “signal”, “message”, “channel”, and “signaling” may sometimes be interchangeably used. It should be noted that, meanings expressed by the terms are consistent when differences between the terms are not emphasized. The terms “of”, “corresponding (e.g., relevant)”, and “corresponding to” may be interchangeably used sometimes. It should be noted that when differences are not emphasized, meanings to be expressed are the same.

In embodiments of this application, a subscript, for example, W₁, may sometimes be written in an different form, for example, W1. Expressed meanings are consistent when differences are not emphasized.

The network architecture and the service scenario described in embodiments of this application are intended to describe the technical solutions in embodiments of this application more clearly, and do not constitute a limitation on the technical solutions provided in embodiments of this application. A person of ordinary skill in the art may know that: With the evolution of the network architecture and the emergence of new service scenarios, the technical solutions provided in embodiments of this application are also applicable to similar technical problems.

A multi-link device (MLD) includes one or more affiliated stations, and the affiliated station is a logical station. “A multi-link device includes an affiliated station” is also briefly described as “A multi-link device includes a station” in embodiments of this application. The affiliated station may be an access point (AP) or a non-access point station (non-AP STA). For ease of description, in this application, a multi-link device whose affiliated station is an AP may be referred to as a multi-link AP, an AP multi-link device, or an AP multi-link device. A multi-link device whose affiliated station is a non-AP STA may be referred to as a multi-link STA, a STA multi-link device, or a STA multi-link device.

The multi-link device MLD may implement wireless communication in compliance with 802.11 series protocols, for example, in compliance with an extremely high throughput (EHT) protocol, or in compliance with an 802.11be-based or 802.11be-compatible protocol, thereby implementing communication with another device. Certainly, the another device may be a multi-link device or may not be a multi-link device.

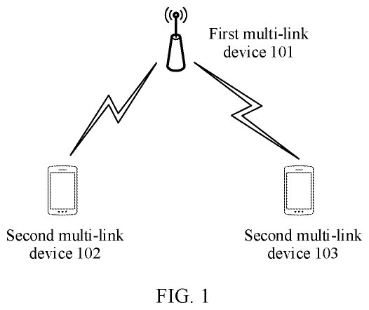

FIG. 1 is a schematic diagram of an architecture of a communication system to which a communication method provided in embodiments of this application is applicable. For ease of understanding embodiments of this application, a communication system shown in FIG. 1 is first used as an example to describe in detail a communication system applicable to embodiments of this application. It should be noted that the solutions in embodiments of this application may also be applied to another mobile communication system, and a corresponding name may also be replaced with a name of a corresponding function in the another mobile communication system.

As shown in FIG. 1, the communication system includes a first multi-link device 101 and at least one second multi-link device, for example, a second multi-link device 102 and a second multi-link device 103. The first multi-link device 101 and the second multi-link device 102 may communicate with each other over multiple links, to achieve an effect of improving a throughput. In a scenario, the first multi-link device 101 is an AP multi-link device, and the second multi-link device 102 is a STA multi-link device. In another scenario, the first multi-link device 101 is a STA multi-link device, and the second multi-link device 102 is an AP multi-link device. In still another scenario, the first multi-link device 101 is an AP multi-link device, and the second multi-link device 102 is an AP multi-link device. In yet another scenario, the first multi-link device 101 is a STA multi-link device, and the second multi-link device 102 is a STA multi-link device. Certainly, the communication system may further include another device. A quantity and types of devices shown in FIG. 1 are merely examples.

It should be noted that a communication method provided in embodiments of this application is applicable to the first multi-link device 101 and the second multi-link device 102 shown in FIG. 1, or applicable to the first multi-link device 101 and the second multi-link device 103 shown in FIG. 1.

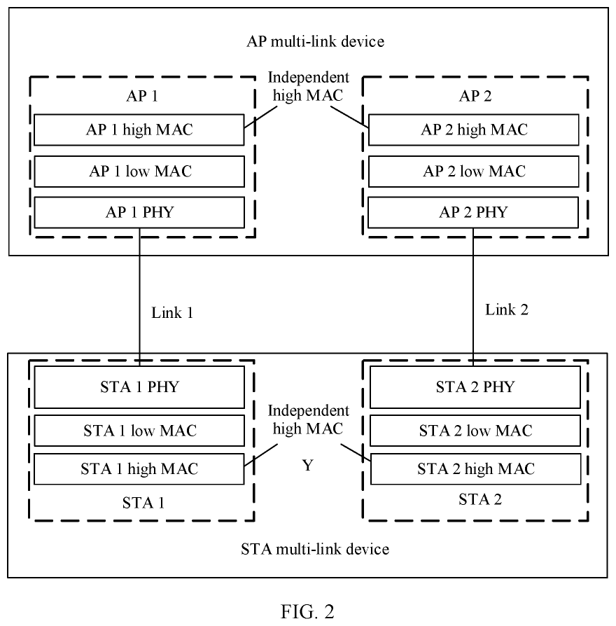

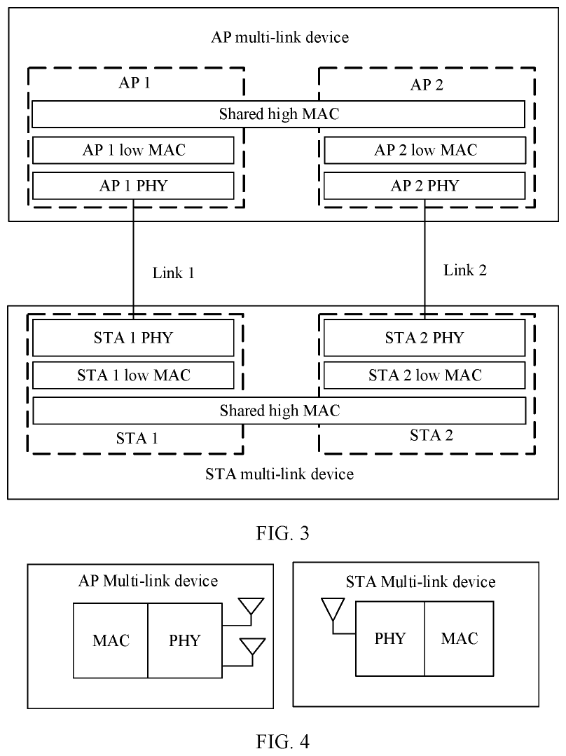

FIG. 2 and FIG. 3 are schematic diagrams of structures of an AP multi-link device and a STA multi-link device that participate in communication. 802.11 standards focus on 802.11 physical layer (PHY) and media access control (MAC) layer parts of an AP multi-link device and a STA multi-link device (such as a mobile phone and a notebook computer).

As shown in FIG. 2, multiple APs included in the AP multi-link device are independent of each other at a low MAC layer and a PHY layer, and are also independent of each other at a high MAC layer. A plurality of STAs included in the STA multi-link device are independent of each other at a low MAC layer and a PHY layer, and are also independent of each other at a high MAC layer.

As shown in FIG. 3, multiple APs included in the AP multi-link device are independent of each other at a low MAC layer and a PHY layer, and share a high MAC layer. Multiple STAs included in the STA multi-link device are independent of each other at a low MAC layer and a PHY layer, and share a high MAC layer.

Certainly, the STA multi-link device may use a structure in which high MAC layers are independent of each other, and the AP multi-link device may use a structure in which a high MAC layer is shared. Alternatively, the STA multi-link device may use a structure in which a high MAC layer is shared, and the AP multi-link device may use a structure in which high MAC layers are independent of each other. For example, the high MAC layer or the low MAC layer may be implemented by one processor in a chip system of the multi-link device, or may be implemented by different processing modules in a chip system.

For example, the multi-link device in embodiments of this application may be a single-antenna device, or may be a multi-antenna device. For example, the multi-link device may be a device with more than two antennas. The quantity of antennas included in the multi-link device is not limited in embodiments of this application. For example, in FIG. 4, the AP multi-link device is a multi-antenna device and the STA multi-link device is a single-antenna device. In embodiments of this application, the multi-link device may allow services of a same access type to be transmitted over different links, or even allow same data packets to be transmitted over different links. Alternatively, the multi-link device may not allow services of a same access type to be transmitted over different links, but may allow services of different access types to be transmitted over different links.

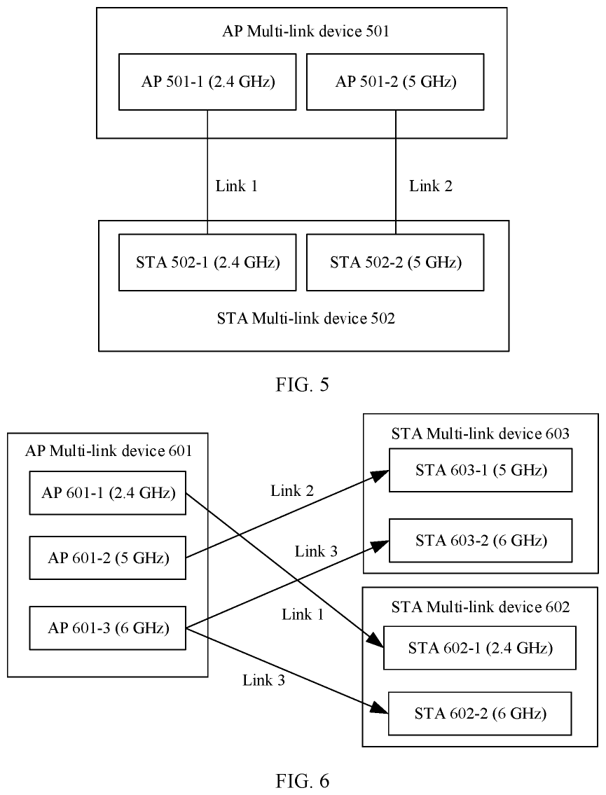

A frequency band on which the multi-link device operates may include but is not limited to sub 1 GHz, 2.4 GHz, 5 GHz, 6 GHz, and a high frequency 60 Ghz. FIG. 5 and FIG. 6 are two schematic diagrams of communication between a multi-link device and another device over multiple links.

FIG. 5 is a schematic diagram 1 of a communication scenario of an AP multi-link device and a STA multi-link device according to an embodiment of this application. FIG. 5 shows a scenario in which an AP multi-link device 501 communicates with a STA multi-link device 502. The AP multi-link device 501 includes an affiliated AP 501-1 and an affiliated AP 501-2, the STA multi-link device 502 includes an affiliated STA 502-1 and an affiliated STA 502-2, and the AP multi-link device 501 communicate with the STA multi-link device 502 in parallel over a link 1 and a link 2.

FIG. 6 is a schematic diagram 2 of a communication scenario of an AP multi-link device and a STA multi-link device according to an embodiment of this application. FIG. 6 shows a scenario in which an AP multi-link device 601 communicates with a STA multi-link device 602 and a STA multi-link device 603. The AP multi-link device 601 includes an affiliated AP 601-1 to an affiliated AP 601-3, the STA multi-link device 602 includes an affiliated STA 602-1 and an affiliated STA 602-2, and the STA multi-link device 603 includes an affiliated STA 603-1 and an affiliated STA 603-2. The AP multi-link device may separately communicate with the STA multi-link device 602 over a link 1 and a link 3, and communicate with the STA multi-link device 603 over a link 2 and a link 3. The STA multi-link device 603 includes the STA 603-1 and the STA 603-2, where the STA 603-1 works on a 5 GHz frequency band, and the STA 603-2 works on a 6 GHz frequency band. The STA multi-link device 602 includes the STA 602-1 and the STA 602-2, where the STA 602-1 works on a 2.4 GHz frequency band, and the STA 602-2 works on a 6 GHz frequency band. The AP 601-1 working on the 2.4 GHz frequency band in the AP multi-link device may perform uplink or downlink data transmission with the STA 602-2 in the STA multi-link device 602 over the link 1. The AP 601-2 working on the 5 GHz frequency band in the AP multi-link device may perform uplink or downlink data transmission with the STA 603-1 working on the 5 GHz frequency band in the STA multi-link device 603 over the link 2. The AP 601-3 working on the 6 GHz frequency band in the AP multi-link device 601 may perform uplink or downlink data transmission with the STA 602-2 working on the 6 GHz frequency band in the STA multi-link device 602 over the link 3, and may also perform uplink or downlink data transmission with the STA 603-2 in the STA multi-link device over the link 3.

It should be noted that FIG. 5 shows that the AP multi-link device supports only two frequency bands, and FIG. 6 only uses an example in which the AP multi-link device supports three frequency bands (e.g., 2.4 GHz, 5 GHz, and 6 GHz), each frequency band corresponds to one link, and the AP multi-link device 601 may work on one or more of link 1, link 2, and link 3 for illustration. In an actual application, the AP multi-link device and the STA multi-link device may further support more or fewer frequency bands. In other words, the AP multi-link device and the STA multi-link device may work on more links or fewer links. This is not limited in this embodiment of this application.

For example, the multi-link device is an apparatus having a wireless communication function. The apparatus may be a device of an entire system, or may be a chip, a processing system, or the like installed in the device of the entire system. The device on which the chip or the processing system is installed may be controlled by the chip or the processing system, to implement the method and functions in embodiments of this application. For example, the multi-link STA in embodiments of this application has a wireless transceiver function, may support the 802.11 series protocols, and may communicate with the multi-link AP, another multi-link STA, or a single-link device. For example, the multi-link STA is any user communication device that allows a user to communicate with an AP and then with a wireless local area network (WLAN). For example, the multi-link STA may be user equipment that can access a network, for example, a tablet computer, a desktop computer, a laptop computer, a notebook computer, an ultra-mobile personal computer (UMPC), a handheld computer, a netbook, a personal digital assistant (PDA), or a mobile phone; or may be an Internet of Things (IoT) node in the Internet of Things, an in-vehicle communication apparatus in the internet of vehicles, or the like. The multi-link STA may alternatively be a chip or a processing system in the foregoing terminals. The multi-link AP in embodiments of this application is an apparatus that provides a service to the multi-link STA, and may support the 802.11 series protocols. For example, the multi-link AP may be a communication entity such as a communication server, a router, a switch, or a network bridge, or the multi-link AP may include various forms of macro base stations, micro base stations, relay stations, or the like. Certainly, the multi-link AP may further be a chip and a processing system in the various forms of devices, to implement the method and functions in embodiments of this application. In addition, the multi-link device may support high-rate and low-latency transmission. With continuous evolution of application scenarios of a WLAN, the multi-link device may be further applied to more scenarios, for example, a sensor node (for example, a smart water meter, a smart electricity meter, and a smart air detection node) in a smart city, a smart device (for example, a smart camera, a projector, a display, a television, a stereo, a refrigerator, and a washing machine) in a smart home, a node in an IoT, an entertainment terminal (for example, a wearable device such as an artificial reality (AR) device and a virtual reality (VR) device), a smart device (for example, a printer or a projector) in a smart office, an Internet of Vehicles device in an internet of vehicles, and some infrastructures (for example, a vending machine, a self-service navigation console in a supermarket, a self-service cash register, and a self-service ordering machine) in a daily life scenario. Forms of the multi-link STA and the multi-link AP are not limited in embodiments of this application, and are merely examples for description herein. The 802.11 series protocols may include 802.11be, 802.11ax, 802.11a/b/g/n/ac, and the like.

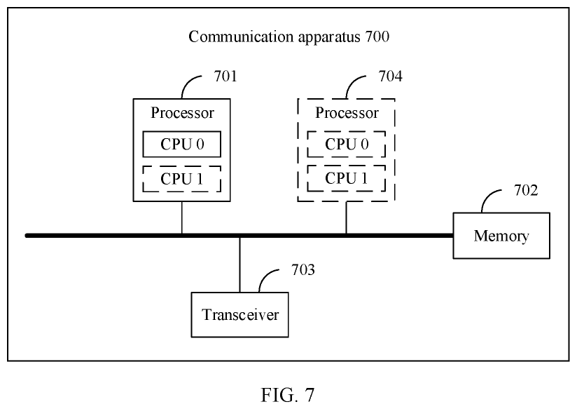

FIG. 7 is a schematic diagram of a structure of a communication apparatus 700 that may be configured to perform a communication method according to embodiments of this application. The communication apparatus 700 may be a first multi-link device, or may be a chip used in the first multi-link device or another component with a function of the first multi-link device. The communication apparatus 700 may be a second multi-link device, or may be a chip used in the second multi-link device or another component with a function of the first multi-link device. As shown in FIG. 7, the communication apparatus 700 may include a processor 701, a memory 702, and a transceiver 703. The processor 701 is coupled to the memory 702 and the transceiver 703, for example, may be connected to the memory 702 and the transceiver 703 through a communication bus.

The following describes each component of the communication apparatus 700 in detail with reference to FIG. 7.

The processor 701 is a control center of the communication apparatus 700, and may be one processor, or may be a collective term of multiple processing elements. For example, the processor 701 is one or more central processing units (CPU), or may be an application-specific integrated circuit (ASIC), or may be one or more integrated circuits configured to implement embodiments of this application, for example, one or more microprocessors (DSPs), or one or more field programmable gate arrays (FPGAs).

The processor 701 may perform various functions of the communication apparatus 700 by running or executing a software program stored in the memory 702 and invoking data stored in the memory 702.

During some implementations, in an embodiment, the processor 701 may include one or more CPUs, such as a CPU 0 and a CPU 1 shown in FIG. 7.

During some implementations, in an embodiment, the communication apparatus 700 may alternatively include multiple processors, for example, the processor 701 and a processor 704 shown in FIG. 7. Each of the processors may be a single-core processor (single-CPU) or may be a multi-core processor (multi-CPU). The processor herein may be one or more communication devices, circuits, and/or processing cores configured to process data (for example, computer program instructions).

The memory 702 may be a read-only memory (ROM), another type of static storage communication device capable of storing static information and instructions, a random access memory (RAM), or another type of dynamic storage communication device capable of storing information and instructions, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, and the like), a magnetic disk storage medium, another magnetic storage communication device, or any other medium capable of carrying or storing expected program code in a form of instructions or data structures and capable of being accessed by a computer, but is not limited thereto. The memory 702 may be integrated with the processor 701, or may exist independently, and is coupled to the processor 701 through an input/output port (not shown in FIG. 7) of the communication apparatus 700. This is not limited in this embodiment of this application.

The memory 702 is configured to store a software program for implementing solutions of this application, and the processor 701 controls the implementation. For the foregoing implementations, refer to the following method embodiments. Details are not described herein again.

The transceiver 703 is configured for communication with another communication apparatus. For example, the communication apparatus 700 is a first multi-link device, and the transceiver 703 may be configured to communicate with a second multi-link device. For another example, the communication apparatus 700 is a second multi-link device, and the transceiver 703 may be configured to communicate with a first multi-link device. In addition, the transceiver 703 may include a receiver and a transmitter (not separately shown in FIG. 7). The receiver is configured to implement a receiving function, and the transmitter is configured to implement a sending function. The transceiver 703 may be integrated with the processor 701, or may exist independently, and is coupled to the processor 701 through an input/output port (not shown in FIG. 7) of the communication apparatus 700. This is not limited in this embodiment of this application.

It should be noted that the structure of the communication apparatus 700 shown in FIG. 7 does not constitute a limitation on the communication apparatus. An actual communication apparatus may include more or fewer components than those shown in the figure, combine some components, or have different component arrangement.

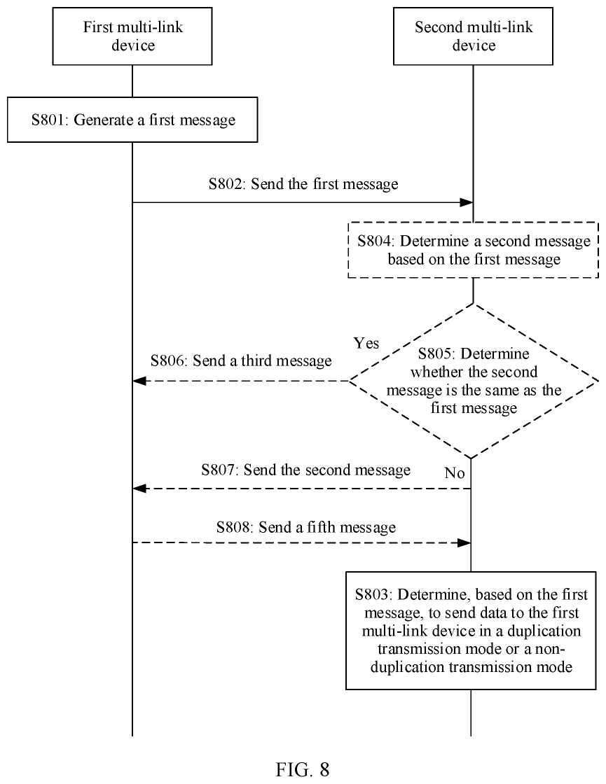

The following describes in detail the communication methods provided in embodiments of this application with reference to FIG. 8 to FIG. 15.

FIG. 8 is a schematic flowchart 1 of a communication method according to an embodiment of this application. The communication method is applicable to communication between the first multi-link device 101 and the second multi-link device 102 or between the first multi-link device 101 and the second multi-link device 103 shown in FIG. 1.

As shown in FIG. 8, the communication method includes the following steps.

S801: A first multi-link device generates a first message.

The first message indicates transmission modes for a second multi-link device to send different types of data.

Optionally, the different types of data may include different traffic identifier (TID) type data, different traffic stream (TS) type data, or the like. A data type is not limited in this application.

The following describes a TID and a TS in detail.

Different TIDs may be mapped to different access categories (AC) to implement quality of service (QoS) transmission. Each link may include one or more TIDs. For example, the link may include eight TIDs, such as TID0, TID1, TID2, TID3, TID4, TID5, TID6, and TID7.

For example, different TIDs may be corresponding to different data types. For example, TID0 to TID3 may be corresponding to a common service such as a video, and TID4 to TID7 may be corresponding to a low-latency service, such as a control service. A specific data type corresponding to each TID is not limited in this application.

A low-latency service has a requirement for a link, for example, low latency and high reliability. Repeat transmission of the low-latency service over multiple links can ensure reliability of the low-latency service. A common service has a lower requirement on latency and reliability of a link. Repeat transmission of the common service on multiple links does not improve user experience, but occupies link resources. Consequently, a transmission rate of a low-latency service on the link cannot be ensured.

The TS is a group of service traffic defined for a media access control (MAC) layer based on traffic specification information and QoS rules. A traffic specification (TSPEC) defines characteristics of service traffic of a source address and a destination address. Compared with the TID, the TS more finely differentiates services, and each link may include one or more TS. A quantity of TS is not limited in this application. For example, the link may include eight TS, such as TS0, TS1, TS2, TS3, TS4, TS5, TS6, and TS7.

For example, different TSs may be corresponding to different data types. For example, TS0 to TS3 may be corresponding to a common service such as a video, and TS4 to TS7 may be corresponding to a low-latency service such as a control service. A specific data type corresponding to each TS is not limited in this application.

In some embodiments, the first message may include transmission mode information of at least one piece of TID type data. In other words, the first message may separately indicate a transmission mode of each piece of TID type data.

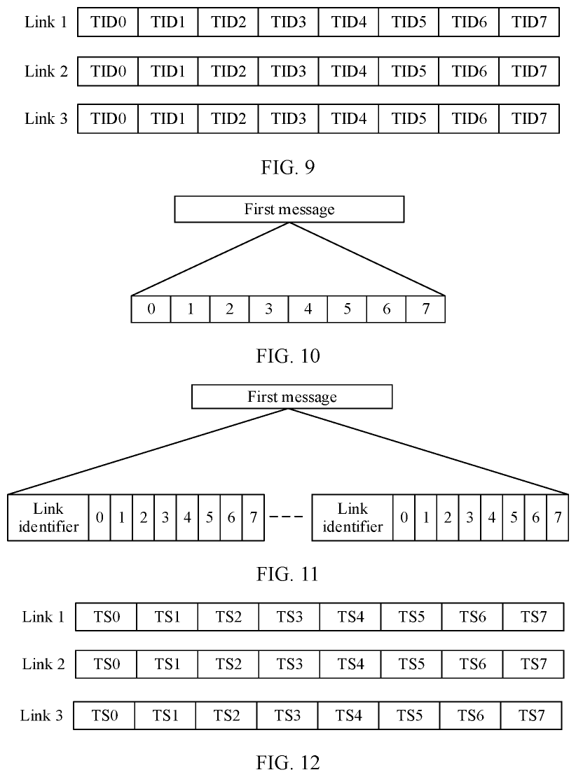

FIG. 9 is a schematic diagram 1 of links according to an embodiment of this application. As shown in FIG. 9, there are a link 1, a link 2, and a link 3 between the first multi-link device and the second multi-link device, and each link includes TID0 data to TID7 data.

FIG. 10 is a schematic diagram 1 of the first message according to an embodiment of this application. As shown in FIG. 10, the first message may include 0 to 7 bits, that is, 8 bits in total.

With reference to FIG. 9 and FIG. 10, bits 0 to 7 are in a one-to-one correspondence with TID0 to TID7. A binary 1 may represent a duplication transmission mode, and a binary 0 may represent a non-duplication transmission mode. For example, the first message is binary 00001111, indicating that a transmission mode of TID0 data to TID3 data is the non-duplication transmission mode, and a transmission mode of TID4 data to TID7 data is the duplication transmission mode. In this case, data corresponding to TID0 to TID3 can be transmitted in the non-duplication transmission mode over each of the link 1, the link 2, and the link 3, and data corresponding to TID4 to TID7 can be transmitted in the duplication transmission mode over each of the link 1, the link 2, and the link 3.

Optionally, the first message may include at least one second multi-link device identifier and the transmission mode information of the at least one piece of TID type data.

For example, with reference to FIG. 1, the first message may include a second multi-link device 102 and transmission mode information of at least one piece of TID type data, and a second multi-link device 103 and transmission mode information of at least one piece of TID type data. The transmission mode information of the at least one piece of TID type data of the second multi-link device 102 may be the same as or different from the transmission mode information of the at least one piece of TID type data of the second multi-link device 103. This is not limited in this application.

In some other embodiments, the first message may include transmission mode information of at least one piece of TID type data corresponding to at least one link. In other words, the first message may separately indicate a transmission mode of each piece of TID type data corresponding to each link.

FIG. 11 is a schematic diagram 2 of the first message according to an embodiment of this application. As shown in FIG. 11, the first message may include at least one link identifier and corresponding 0 to 7 bits, where a binary 1 may represent a duplication transmission mode, and a binary 0 may represent a non-duplication transmission mode.

With reference to FIG. 9 and FIG. 11, the first message may include: link 1: 00001111; link 2: 11111111; and link 3: 11110000, indicating that a transmission mode of TID0 data to TID3 data corresponding to the link 1 is the non-duplication transmission mode, a transmission mode of TID0 data to TID3 data corresponding to the link 2 and the link 3 is the duplication transmission mode, a transmission mode of TID4 data to TID7 data corresponding to the link 1 and the link 2 is the duplication transmission mode, and a transmission mode of TID4 data to TID7 data corresponding to the link 3 is the non-duplication transmission mode.

Optionally, the first message may include at least one second multi-link device identifier and the transmission mode information of the at least one piece of TID type data corresponding to at least one link.

For example, with reference to FIG. 1, the first message may include a second multi-link device 102 and transmission mode information of at least one piece of TID type data corresponding to at least one link, and a second multi-link device 103 and transmission mode information of at least one piece of TID type data corresponding to at least one link. The transmission mode information of the at least one piece of TID type data corresponding to the at least one link of the second multi-link device 102 may be the same as or different from the transmission mode information of the at least one piece of TID type data corresponding to the at least one link of the second multi-link device 103. This is not limited in this application.

In still some other embodiments, the first message may include transmission mode information of at least one piece of TS type data. In other words, the first message may separately indicate a transmission mode of each piece of TS type data.

FIG. 12 is a schematic diagram 2 of links according to an embodiment of this application. As shown in FIG. 12, there are a link 1, a link 2, and a link 3 between the first multi-link device and the second multi-link device, and each link includes TS0 data to TS7 data.

With reference to FIG. 10 and FIG. 12, bits 0 to 7 are in a one-to-one correspondence with TS0 to TS7. A binary 1 represents a duplication transmission mode, and a binary 0 represents a non-duplication transmission mode. For example, the first message is binary 00001111, indicating that a transmission mode of TS0 data to TS3 data is the non-duplication transmission mode, and a transmission mode of TS4 data to TS7 data is the duplication transmission mode. In this case, data corresponding to TS0 to TS3 can be transmitted in the non-duplication transmission mode over each of the link 1, the link 2, and the link 3, and data corresponding to TS4 to TS7 can be transmitted in the duplication transmission mode over each of the link 1, the link 2, and the link 3.

Optionally, the first message may include at least one second multi-link device identifier and the transmission mode information of the at least one piece of TS type data.

For example, with reference to FIG. 1, the first message may include a second multi-link device 102 and transmission mode information of at least one piece of TS type data, and a second multi-link device 103 and transmission mode information of at least one piece of TS type data. The transmission mode information of the at least one piece of TS type data of the second multi-link device 102 may be the same as or different from the transmission mode information of the at least one piece of TS type data of the second multi-link device 103. This is not limited in this application.

In still some other embodiments, the first message may include transmission mode information of at least one piece of TS type data corresponding to at least one link.

With reference to FIG. 11 and FIG. 12, the first message may include: link 1: 00001111; link 2: 11111111; and link 3: 11110000. In this case, the first message may indicate that a transmission mode of TS0 data to TS3 data corresponding to the link 1 is a non-duplication transmission mode, a transmission mode of TS0 data to TS3 data corresponding to the link 2 and the link 3 is a duplication transmission mode, a transmission mode of TS4 data to TS7 data corresponding to the link 1 and the link 2 is the duplication transmission mode, and a transmission mode of TS4 data to TS7 data corresponding to the link 3 is the non-duplication transmission mode.

Optionally, the first message may include at least one second multi-link device identifier and the transmission mode information of the at least one piece of TS type data corresponding to at least one link.

For example, with reference to FIG. 1, the first message may include a second multi-link device 102 and transmission mode information of at least one piece of TS type data corresponding to at least one link, and a second multi-link device 103 and transmission mode information of at least one piece of TS type data corresponding to at least one link. The transmission mode information of the at least one piece of TS type data corresponding to the at least one link of the second multi-link device 102 may be the same as or different from the transmission mode information of the at least one piece of TS type data corresponding to the at least one link of the second multi-link device 103. This is not limited in this application.

In still some other embodiments, the first message may include one or more of a transmission delay threshold, a transmission packet loss rate threshold, or a buffer size threshold of at least one piece of TID type data.

With reference to FIG. 9, the first message may include one or more of a transmission delay threshold, a transmission packet loss rate threshold, or a buffer size threshold of TID0 data to TID7 data, and may indicate transmission delay thresholds, transmission packet loss rate thresholds, or buffer size thresholds of TID0 data to TID7 data of the link 1, the link 2, and the link 3. In addition, the transmission delay thresholds, the transmission packet loss rate thresholds, and the buffer size thresholds of the TID0 data to the TID7 data of the link 1, the link 2, and the link 3 are correspondingly the same. For example, the transmission delay threshold of the TID0 data of the link 1 is the same as the transmission delay threshold of the TID0 data of the link 2 and the transmission delay threshold of the TID0 data of the link 3, or the transmission packet loss rate threshold of the TID0 data of the link 1 is the same as the transmission packet loss rate threshold of the TID0 data of the link 2 and the transmission packet loss rate threshold of the TID0 data of the link 3, which are not enumerated in this application.

Optionally, that the first message indicates transmission modes for the second multi-link device to send different types of data may include: If a first condition is met, the first message indicates to transmit TID type data in a duplication transmission mode. Otherwise, the first message indicates to transmit TID type data in a non-duplication transmission mode.

The first condition may include: a transmission delay of the TID type data is greater than the transmission delay threshold of the TID type data, or a transmission packet loss rate of the TID type data is greater than the transmission packet loss rate threshold of the TID type data, or a buffer size of the TID type data is greater than the buffer size threshold of the TID type data.

Optionally, the first message may include at least one second multi-link device identifier and first threshold information. The first threshold information includes one or more of the transmission delay threshold, the transmission packet loss rate threshold, or the buffer size threshold of the at least one piece of TID type data.

For example, with reference to FIG. 1, the first message may include a second multi-link device 102 and first threshold information, and a second multi-link device 103 and first threshold information.

It should be noted that the first threshold information of the second multi-link device 102 may be the same as or different from the first threshold information of the second multi-link device 103. This is not limited in this application.

In still some other embodiments, the first message may include one or more of a transmission delay threshold, a transmission packet loss rate threshold, or a buffer size threshold of at least one piece of TID type data corresponding to at least one link.

With reference to FIG. 9, the first message may include one or more of a transmission delay threshold, a transmission packet loss rate threshold, or a buffer size threshold of TID0 data to TID7 data corresponding to the link 1 and/or the link 2 and/or the link 3. For example, the link 1: a transmission delay threshold, and/or a transmission packet loss rate threshold, and/or a buffer size threshold of the TID0 data, and similarly, a transmission delay threshold, and/or a transmission packet loss rate threshold, and/or a buffer size threshold of the TID7 data. The link 2: a transmission delay threshold, and/or a transmission packet loss rate threshold, and/or a buffer size threshold of the TID0 data, and similarly, a transmission delay threshold, and/or a transmission packet loss rate threshold, and/or a buffer size threshold of the TID7 data. The link 3: a transmission delay threshold, and/or a transmission packet loss rate threshold, and/or a buffer size threshold of the TID0 data, and similarly, a transmission delay threshold, and/or a transmission packet loss rate threshold, and/or a buffer size threshold of the TID7 data.

It should be noted that each link may be flexibly set. For example, the transmission delay threshold of the TID0 data corresponding to the link 1 may be different from the transmission delay threshold of the TID0 data corresponding to the link 2.

Optionally, that the first message indicates transmission modes for the second multi-link device to send different types of data may include: If a second condition is met, the first message indicates to transmit TID type data corresponding to a link in a duplication transmission mode. Otherwise, the first message indicates to transmit TID type data corresponding to a link in a non-duplication transmission mode.

The second condition may include: a transmission delay of the TID type data corresponding to the link is greater than the transmission delay threshold of the TID type data corresponding to the link, or a transmission packet loss rate of the TID type data corresponding to the link is greater than the transmission packet loss rate threshold of the TID type data corresponding to the link, or a buffer size of the TID type data corresponding to the link is greater than the buffer size threshold of the TID type data corresponding to the link.

Optionally, the first message may include at least one second multi-link device identifier and second threshold information, and the second threshold information includes one or more of the transmission delay threshold, the transmission packet loss rate threshold, or the buffer size threshold of the at least one piece of TID type data corresponding to the at least one link.

For example, with reference to FIG. 1, the first message may include a second multi-link device 102 and second threshold information, and a second multi-link device 103 and second threshold information. The second threshold information of the second multi-link device 102 may be the same as or different from the second threshold information of the second multi-link device 103. This is not limited in this application.

In still some other embodiments, the first message may include one or more of a transmission delay threshold, a transmission packet loss rate threshold, or a buffer size threshold of at least one piece of TS type data.

With reference to FIG. 12, the first message may include one or more of a transmission delay threshold, a transmission packet loss rate threshold, or a buffer size threshold of TS0 data to TS7 data, and may indicate transmission delay thresholds, transmission packet loss rate thresholds, or buffer size thresholds of TS0 data to TS7 data of the link 1, the link 2, and the link 3. In addition, the transmission delay thresholds, the transmission packet loss rate thresholds, and the buffer size thresholds of the TS0 data to the TS7 data of the link 1, the link 2, and the link 3 are correspondingly the same. For example, the transmission delay threshold of the TS0 data of the link 1 is the same as the transmission delay threshold of the TS0 data of the link 2 and the transmission delay threshold of the TS0 data of the link 3, or the transmission packet loss rate threshold of the TS0 data of the link 1 is the same as the transmission packet loss rate threshold of the TS0 data of the link 2 and the transmission packet loss rate threshold of the TS0 data of the link 3, which are not enumerated in this application.

Optionally, that the first message indicates transmission modes for the second multi-link device to send different types of data may include: If a third condition is met, the first message indicates to transmit TS type data in a duplication transmission mode. Otherwise, the first message indicates to transmit TS type data in a non-duplication transmission mode.

The third condition may include: a transmission delay of the TS type data is greater than the transmission delay threshold of the TS type data, or a transmission packet loss rate of the TS type data is greater than the transmission packet loss rate threshold of the TS type data, or a buffer size of the TS type data is greater than the buffer size threshold of the TS type data.

Optionally, the first message may include at least one second multi-link device identifier and third threshold information. The third threshold information includes one or more of the transmission delay threshold, the transmission packet loss rate threshold, or the buffer size threshold of the at least one piece of TS type data.

For example, with reference to FIG. 1, the first message may include a second multi-link device 102 and third threshold information, and a second multi-link device 103 and third threshold information. The third threshold information of the second multi-link device 102 may be the same as or different from the third threshold information of the second multi-link device 103. This may be set based on an actual requirement, and is not limited in this application.

In still some other embodiments, the first message may include one or more of a transmission delay threshold, a transmission packet loss rate threshold, or a buffer size threshold of at least one piece of TS type data corresponding to at least one link.

With reference to FIG. 12, the first message may include one or more of a transmission delay threshold, a transmission packet loss rate threshold, or a buffer size threshold of TS0 data to TS7 data corresponding to the link 1 and/or the link 2 and/or the link 3.

For example, the link 1: a transmission delay threshold, a transmission packet loss rate threshold, and/or a buffer size threshold of the TS0 data, and similarly, a transmission delay threshold, a transmission packet loss rate threshold, and/or a buffer size threshold of the TS7 data. The link 2: a transmission delay threshold, a transmission packet loss rate threshold, and/or a buffer size threshold of the TS0 data, and similarly, a transmission delay threshold, a transmission packet loss rate threshold, and/or a buffer size threshold of the TS7 data. The link 3: a transmission delay threshold, a transmission packet loss rate threshold, and/or a buffer size threshold of the TS0 data, and similarly, a transmission delay threshold, a transmission packet loss rate threshold, and/or a buffer size threshold of the TS7 data.

It should be noted that each link may be flexibly set. For example, the transmission delay threshold of the TS0 data corresponding to the link 1 may be different from the transmission delay threshold of the TS0 data corresponding to the link 2.

Optionally, that the first message indicates transmission modes for the second multi-link device to send different types of data may include: If a fourth condition is met, the first message indicates to transmit TS type data corresponding to a link in a duplication transmission mode. Otherwise, the first message indicates to transmit TS type data corresponding to a link in a non-duplication transmission mode.

The fourth condition may include: a transmission delay of the TS type data corresponding to the link is greater than the transmission delay threshold of the TS type data corresponding to the link, or a transmission packet loss rate of the TS type data corresponding to the link is greater than the transmission packet loss rate threshold of the TS type data corresponding to the link, or a buffer size of the TS type data corresponding to the link is greater than the buffer size threshold of the TS type data corresponding to the link.

Optionally, the first message may include at least one second multi-link device identifier and fourth threshold information, and the fourth threshold information includes one or more of the transmission delay threshold, the transmission packet loss rate threshold, or the buffer size threshold of the at least one piece of TS type data corresponding to the at least one link.

For example, with reference to FIG. 1, the first message may include a second multi-link device 102 and fourth threshold information, and a second multi-link device 103 and fourth threshold information. It should be noted that the fourth threshold information of the second multi-link device 102 may be the same as or different from the fourth threshold information of the second multi-link device 103. This may be set based on an actual requirement, and is not limited in this application.

In still some embodiments, the first message may include a link identifier and a data transmission mode.

With reference to FIG. 9 or FIG. 12, the first message may include: link 1: duplication transmission mode; link 2: duplication transmission mode; and link 3: non-duplication transmission mode.

Optionally, the first message may include at least one second multi-link device identifier, a link identifier, and a data transmission mode.

For example, with reference to FIG. 1, if the second multi-link device 102 and the second multi-link device 103 each include a link 1 and a link 2, and the first message may include: the second multi-link device 102, the link 1, the duplication transmission mode, the link 2, the duplication transmission mode; and the second multi-link device 103, the link 1, the duplication transmission mode, the link 2, the duplication transmission mode.

It should be noted that FIG. 9 to FIG. 12 are examples of this application. In this application, a quantity of links between the first multi-link device and the second multi-link device is not limited, a quantity of pieces of TID data included in each link is not limited, a quantity of pieces of TS data included in each link is not limited, and similarly, a quantity of bits of the first message is not limited.

The foregoing transmission mode may include a duplication transmission mode and a non-duplication transmission mode. The duplication transmission mode is transmitting same data over at least two links.

It is assumed that the first multi-link device and the second multi-link device may communicate with each other over the link 1, the link 2, and the link 3. Same data may be transmitted over the link 1 and the link 2, and different data may be transmitted over the link 3. Alternatively, same data may be transmitted over the link 1, the link 2, and the link 3.

Optionally, the duplication transmission mode may include a synchronous duplication transmission mode and an asynchronous duplication transmission mode.

The synchronous duplication transmission mode is simultaneously transmitting same data over at least two links.

FIG. 13 is a schematic diagram of a synchronous duplication transmission mode according to an embodiment of this application.

As shown in FIG. 13, the first multi-link device and the second multi-link device may communicate with each other over a link 1 and a link 2. For example, the links include TID0 type data. The link 1 and the link 2 simultaneously access a channel, and simultaneously send data 1, 2, 3, and 4.

It should be noted that FIG. 13 is merely an example. Uplink or downlink data may be transmitted between the first multi-link device and the second multi-link device over at least two links, for example, the link 1, the link 2, and a link 3. The link 3 may access a channel at the same time as the link 1 and the link 2, and send same data. Alternatively, the link 3 may access a channel at different times with the link 1 and the link 2, and then send different data. This is not limited in this application.

The asynchronous duplication transmission mode is transmitting same data over at least two links at different times.

FIG. 14 is a schematic diagram of an asynchronous duplication transmission mode according to an embodiment of this application.

As shown in FIG. 14, the first multi-link device and the second multi-link device may communicate with each other over a link 1 and a link 2. For example, the links include TID0 type data. The link 1 and the link 2 access a channel at different times, and send data 1, 2, 3, and 4.

It should be noted that FIG. 14 is merely an example. Uplink or downlink data may be transmitted between the first multi-link device and the second multi-link device over at least two links, for example, the link 1, the link 2, and a link 3. The link 3 may access a channel at different times with the link 1 and the link 2, and send same data. Alternatively, the link 3 may access a channel at different times with the link 1 and the link 2, and then send different data. This is not limited in this application.

Optionally, the non-duplication transmission may be transmitting different data over a first link and a second link. The second link is a link between the first multi-link device and the second multi-link device other than the first link.

It is assumed that the first multi-link device and the second multi-link device may communicate with each other over the link 1, the link 2, and the link 3, and different data may be transmitted over the link 1, the link 2, and the link 3. When the first link is the link 1, the second link is the link 2 and the link 3. When the first link is the link 2, the second link is the link 1 and the link 3. When the first link is the link 3, the second link is the link 1 and the link 2.

Optionally, the non-duplication transmission mode may include a synchronous non-duplication transmission mode and an asynchronous non-duplication transmission mode.

The synchronous non-duplication transmission mode is simultaneously transmitting different data over the first link and the second link.

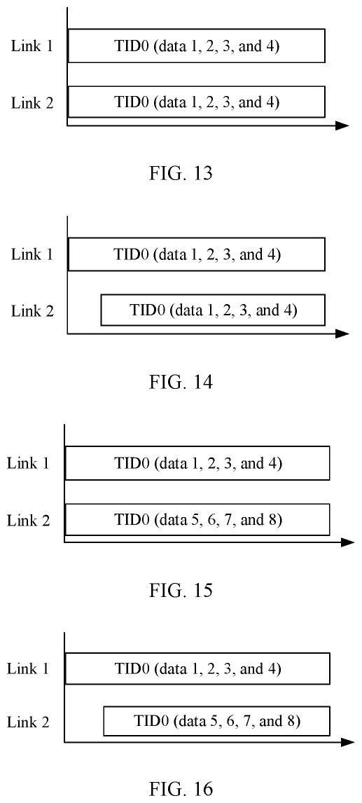

FIG. 15 is a schematic diagram of a synchronous non-duplication transmission mode according to an embodiment of this application.

As shown in FIG. 15, the first multi-link device and the second multi-link device communicate with each other over a link 1 and a link 2. For example, the links include TID0 type data. The link 1 and the link 2 simultaneously access a channel, the link 1 sends data 1, 2, 3, and 4, and the link 2 sends data 5, 6, 7, and 8.

It should be noted that FIG. 15 is merely an example. Uplink or downlink data may be transmitted between the first multi-link device and the second multi-link device over at least two links, for example, the link 1, the link 2, and a link 3. The link 3 may access a channel at the same time as the link 1 and the link 2, and simultaneously send different data, for example, data 9 and 10.

The asynchronous non-duplication transmission mode is transmitting different data over the first link and the second link at different times.

FIG. 16 is a schematic diagram of an asynchronous non-duplication transmission mode according to an embodiment of this application.

As shown in FIG. 16, the first multi-link device and the second multi-link device communicate with each other over a link 1 and a link 2. For example, the links include TID0 type data. The link 1 and the link 2 access a channel at different times, the link 1 sends data 1, 2, 3, and 4, and the link 2 sends data 5, 6, 7, and 8.

It should be noted that FIG. 16 is merely an example. Uplink or downlink data may be transmitted between the first multi-link device and the second multi-link device over at least two links, for example, the link 1, the link 2, and a link 3. The link 3 may access a channel at different times with the link 1 and the link 2, and send different data, for example, data 9 and 10.

S802: The first multi-link device sends the first message. Correspondingly, the second multi-link device receives the first message from the first multi-link device.

For example, the first message may be a management frame such as a beacon frame, or a negotiation frame such as an association frame, an add block ack (ADDBA) frame, or a TID information exchange frame. The first message may occupy a TID-to-duplication mode field.

In some embodiments, that the first multi-link device sends the first message in S802 may include: The first multi-link device sends the first message in a broadcast manner.

In some other embodiments, that the first multi-link device sends the first message in S802 may include: The first multi-link device sends the first message to at least one second multi-link device.

With reference to FIG. 6, for example, the first multi-link device is the AP multi-link device 601, and the second multi-link device is the STA multi-link device 602. The first multi-link device may send the first message in any one or more of the following manners: The AP multi-link device 601 sends the first message to the STA multi-link device 602 over the link 1, and/or the AP multi-link device 601 sends the first message to the STA multi-link device 602 over the link 3.

For example, that the AP multi-link device 601 sends the first message to the STA multi-link device 602 over the link 1 may include: The AP 601-1 of the AP multi-link device 601 sends the first message to the STA 602-1 of the STA multi-link device 602 over the link 1. That the AP multi-link device 601 sends the first message to the STA multi-link device 602 over the link 3 may include: The AP 601-3 of the AP multi-link device 601 sends the first message to the STA 602-2 of the STA multi-link device 602 over the link 3.

S803: The second multi-link device determines, based on the first message, to send data to the first multi-link device in the duplication transmission mode or the non-duplication transmission mode.

In other words, the second multi-link device may directly determine, based on an indication of the first multi-link device, to send the data to the first multi-link device in the duplication transmission mode or the non-duplication transmission mode.

In some embodiments, the second multi-link device may determine, based on the transmission mode information of the at least one piece of TID type data, to send the data to the first multi-link device in the duplication transmission mode or the non-duplication transmission mode.

With reference to FIG. 9 and FIG. 10, bits 0 to 7 are in a one-to-one correspondence with TID0 to TID7. A binary 1 represents a duplication transmission mode, and a binary 0 represents a non-duplication transmission mode. For example, if the first message is binary 00001111, the second multi-link device may determine to transmit, over each of the link 1, the link 2, and the link 3, data corresponding to TID0 to TID3 in the non-duplication transmission mode and data corresponding to TID4 to TID7 in the duplication transmission mode.

Optionally, the second multi-link device may determine, based on the at least one second multi-link device identifier and the transmission mode information of the at least one piece of TID type data, to send the data to the first multi-link device in the duplication transmission mode or the non-duplication transmission mode.

With reference to FIG. 1, FIG. 9, and FIG. 10, for example, the first message includes: second multi-link device 102: 00001111, and second multi-link device 103: 11110000. In this case, the second multi-link device 102 may determine to transmit, over each of a link 1, a link 2, and a link 3, data corresponding to TID0 to TID3 in the non-duplication transmission mode, and data corresponding to TID4 to TID7 in the duplication transmission mode. The second multi-link device 103 may determine to transmit, over each of a link 1, a link 2, and a link 3, data corresponding to TID0 to TID3 in the duplication transmission mode, and data corresponding to TID4 to TID7 in the non-duplication transmission mode.

In some other embodiments, the second multi-link device may determine, based on the transmission mode information of the at least one piece of TID type data corresponding to the at least one link, to send the data to the first multi-link device in the duplication transmission mode or the non-duplication transmission mode.

With reference to FIG. 9 and FIG. 11, bits 0 to 7 are in a one-to-one correspondence with TID0 to TID7. A binary 1 represents a duplication transmission mode, and a binary 0 represents a non-duplication transmission mode. For example, the first message includes: link 1: 00001111; link 2: 11111111; and link 3: 11110000. The second multi-link device may determine to transmit data corresponding to TID0 to TID3 over the link 1 in the non-duplication transmission mode, transmit data corresponding to TID0 to TID3 over the link 2 and the link 3 in the duplication transmission mode, transmit data corresponding to TID4 to TID7 over the link 1 and the link 2 in the duplication transmission mode, and transmit data corresponding to TID4 to TID7 over the link 3 in the non-duplication transmission mode.

Optionally, the second multi-link device may determine, based on the at least one second multi-link device identifier and the transmission mode information of the at least one piece of TID type data corresponding to the at least one link, to send the data to the first multi-link device in the duplication transmission mode or the non-duplication transmission mode.

With reference to FIG. 1, FIG. 9, and FIG. 11, for example, the first message includes: second multi-link device 102: link 1, 00001111, link 2, 00001111, and link 3, 00001111; and second multi-link device 103: link 1, 11110000, link 2, 11110000, and link 3, 00000000. In this case, the second multi-link device 102 may determine to transmit, over each of the link 1, the link 2, and the link 3, data corresponding to TID0 to TID3 in the non-duplication transmission mode, and data corresponding to TID4 to TID7 in the duplication transmission mode. The second multi-link device 103 may determine to transmit, over each of the link 1 and the link 2, data corresponding to TID0 to TID3 in the duplication transmission mode, and data corresponding to TID4 to TID7 in the non-duplication transmission mode. The second multi-link device 103 may determine to transmit data corresponding to TID0 to TID7 over the link 3 in the non-duplication transmission mode.

In still some other embodiments, the second multi-link device may determine, based on the transmission mode information of the at least one piece of TS type data, to send the data to the first multi-link device in the duplication transmission mode or the non-duplication transmission mode.

With reference to FIG. 10 and FIG. 12, bits 0 to 7 are in a one-to-one correspondence with TS0 to TS7. A binary 1 represents a duplication transmission mode, and a binary 0 represents a non-duplication transmission mode. For example, if the first message is binary 00001111, the second multi-link device may determine to transmit, over each of the link 1, the link 2, and the link 3, data corresponding to TS0 to TS3 in the non-duplication transmission mode and data corresponding to TS4 to TS7 in the duplication transmission mode.

Optionally, the second multi-link device may determine, based on the at least one second multi-link device identifier and the transmission mode information of the at least one piece of TS type data, to send the data to the first multi-link device in the duplication transmission mode or the non-duplication transmission mode.

With reference to FIG. 1, FIG. 10, and FIG. 12, for example, the first message includes: second multi-link device 102: 00001111, and second multi-link device 103: 11110000. In this case, the second multi-link device 102 may determine to transmit, over each of a link 1, a link 2, and a link 3, data corresponding to TS0 to TS3 in the non-duplication transmission mode, and data corresponding to TS4 to TS7 in the duplication transmission mode. The second multi-link device 103 may determine to transmit, over each of a link 1, a link 2, and a link 3, data corresponding to TS0 to TS3 in the duplication transmission mode, and data corresponding to TS4 to TS7 in the non-duplication transmission mode.

In still some other embodiments, the second multi-link device may determine, based on the transmission mode information of the at least one piece of TS type data corresponding to the at least one link, to send the data to the first multi-link device in the duplication transmission mode or the non-duplication transmission mode.

With reference to FIG. 11 and FIG. 12, bits 0 to 7 are in a one-to-one correspondence with TS0 to TS7. A binary 1 represents a duplication transmission mode, and a binary 0 represents a non-duplication transmission mode. For example, the first message includes: link 1: 00001111; link 2: 11111111; and link 3: 11110000. The second multi-link device may determine to transmit data corresponding to TS0 to TS3 over the link 1 in the non-duplication transmission mode, transmit data corresponding to TS0 to TS3 over the link 2 and the link 3 in the duplication transmission mode, transmit data corresponding to TS4 to TS7 over the link 1 and the link 2 in the duplication transmission mode, and transmit data corresponding to TS4 to TS7 over the link 3 in the non-duplication transmission mode.

Optionally, the second multi-link device may determine, based on the at least one second multi-link device identifier and the transmission mode information of the at least one piece of TS type data corresponding to the at least one link, to send the data to the first multi-link device in the duplication transmission mode or the non-duplication transmission mode.

With reference to FIG. 1, FIG. 11, and FIG. 12, for example, the first message includes: second multi-link device 102: link 1, 00001111, link 2, 00001111, and link 3, 00001111; second multi-link device 103: link 1, 11110000, link 2, 11110000, and link 3, 00000000. The second multi-link device 102 may determine to transmit, over each of the link 1, the link 2, and the link 3, data corresponding to TS0 to TS3 in the non-duplication transmission mode, and data corresponding to TS4 to TS7 in the duplication transmission mode. The second multi-link device 103 may determine to transmit, over each of the link 1 and the link 2, data corresponding to TS0 to TS3 in the duplication transmission mode, and data corresponding to TS4 to TS7 in the non-duplication transmission mode. The second multi-link device 103 may determine to transmit data corresponding to TS0 to TS7 over the link 3 in the non-duplication transmission mode.

Optionally, that the second multi-link device determines, based on the first message, to send data to the first multi-link device in the duplication transmission mode or the non-duplication transmission mode may include: If the first condition is met, the second multi-link device determines to send the data to the first multi-link device in the duplication transmission mode. Otherwise, the second multi-link device determines to send the data to the first multi-link device in the non-duplication transmission mode.

For some implementations of the first condition, refer to S801. Details are not described herein again.

Optionally, that the second multi-link device determines, based on the first message, to send data to the first multi-link device in the duplication transmission mode or the non-duplication transmission mode may include: If the second condition is met, the second multi-link device determines to send the data to the first multi-link device in the duplication transmission mode. Otherwise, the second multi-link device determines to send the data to the first multi-link device in the non-duplication transmission mode.

For some implementations of the second condition, refer to S801. Details are not described herein again.

Optionally, that the second multi-link device determines, based on the first message, to send data to the first multi-link device in the duplication transmission mode or the non-duplication transmission mode may include: If the third condition is met, the second multi-link device determines to send the data to the first multi-link device in the duplication transmission mode. Otherwise, the second multi-link device determines to send the data to the first multi-link device in the non-duplication transmission mode.

For some implementations of the third condition, refer to S801. Details are not described herein again.

Optionally, that the second multi-link device determines, based on the first message, to send data to the first multi-link device in the duplication transmission mode or the non-duplication transmission mode may include: If the fourth condition is met, the second multi-link device determines to send the data to the first multi-link device in the duplication transmission mode. Otherwise, the second multi-link device determines to send the data to the first multi-link device in the non-duplication transmission mode.

For some implementations of the fourth condition, refer to S801. Details are not described herein again.

In this way, for example, a link includes a low-latency service and a common service. The duplication transmission mode is used for the low-latency service in the link, to ensure a low latency and high reliability of the low-latency service. The non-duplication transmission mode is used for the common service in the link, to ensure a delay and reliability of the common service, reduce overheads generated when a duplicate common service is transmitted over the link, and improve a transmission rate of subsequent data in the link. In this way, a low-latency requirement of the low-latency service on the link can be met.

In a possible design solution, before the second multi-link device determines, based on the first message, to send the data to the first multi-link device in the duplication transmission mode or the non-duplication transmission mode in S803, the communication method provided in this application may further include the following S804 to S808.

S804: The second multi-link device determines a second message based on the first message.

Optionally, the second message indicates transmission modes for the second multi-link device to send different types of data.

In other words, the second multi-link device may negotiate with the first multi-link device to determine the transmission modes for the second multi-link device to send the different types of data.

For some implementations of the second message, refer to implementations of the first message in S801. Details are not described herein again.

S805: The second multi-link device determines whether the second message is the same as the first message.

FIG. 9 and FIG. 10 show an example in which the first message and the second message each include transmission mode information of at least one piece of TID type data. It is assumed that the first message is binary 00001111, indicating that a transmission mode TID0 data to TID3 data is the non-duplication transmission mode, and a transmission mode of TID4 data to TID7 data is the duplication transmission mode. The second message is binary 11111000, indicating that a transmission mode of TID0 data to TID4 data is the duplication transmission mode, and a transmission mode of TID5 data to TID7 data is the non-duplication transmission mode. In this case, the second message is different from the first message. If the first message is binary 00001111, and the second message is binary 00001111, the second message is the same as the first message.

FIG. 10 and FIG. 12 show an example in which the first message and the second message each include transmission mode information of at least one piece of TS type data. It is assumed that the first message is binary 00001111, indicating that a transmission mode TS0 data to TS3 data is the non-duplication transmission mode, and a transmission mode of TS4 data to TS7 data is the duplication transmission mode. The second message is binary 00001111, indicating that a transmission mode of TS0 data to TS3 data is the non-duplication transmission mode, and a transmission mode of TS4 data to TS7 data is the duplication transmission mode. In this case, the second message is the same as the first message. If the first message is binary 00001111, and the second message is binary 11110000, the second message is different from the first message.

It should be noted that in this application, only an example of determining whether the second message is the same as the first message when the first message and the second message include the transmission mode information of the at least one piece of TID type data, and the first message and the second message include the transmission mode information of the at least one piece of TS type data is provided. When the first message and the second message include other content, whether the second message is the same as the first message can also be determined in this application. Details are not described herein again.

In other words, whether the first message is the same as the second message may be determined by using content included in the first message and the second message. If the second message is the same as the first message, the second multi-link device may perform the following S806. If the second message is different from the first message, the second multi-link device may perform the following S807.

In a possible design solution, after the second multi-link device determines the second message based on the first message in S804, the second multi-link device may not perform S805, and may directly send the second message to the first multi-link device. The first multi-link device determines whether the second message is the same as the first message. If the second message and the first message are the same, the first multi-link device may send, to the second multi-link device, a message indicating that the first message is the same as the second message and/or that a negotiation succeeds. Correspondingly, the second multi-link device may receive, from the first multi-link device, the message indicating that the first message is the same as the second message and/or that the negotiation succeeds. The second multi-link device may perform S803. If the second message and the first message are different, the first multi-link device may perform the following S806.

S806: The second multi-link device sends a third message to the first multi-link device. Correspondingly, the first multi-link device receives the third message from the second multi-link device.

Optionally, the third message may indicate that the second multi-link device accepts the first message, and/or that the first message is the same as the second message, and/or that the negotiation succeeds.

In other words, the second multi-link device may send a negotiation result to the first multi-link device. If the third message indicates that the second multi-link device accepts the first message, it indicates that the negotiation succeeds, and the second message is the same as the first message. The second multi-link device may perform S803.

S807: The second multi-link device sends the second message to the first multi-link device. Correspondingly, the first multi-link device receives the second message from the second multi-link device.

For some implementations of the second message, refer to S804. Details are not described herein again.

That is, if the second multi-link device does not accept the first message, and the negotiation with the first multi-link device fails, the second multi-link device may send, to the first multi-link device, a message that is determined by the second multi-link device and that indicates transmission modes for the second multi-link device to send different types of data, to implicitly indicate that the negotiation fails.

Optionally, if the second multi-link device does not accept the first message, and the negotiation with the first multi-link device fails, the second multi-link device may send a fourth message to the first multi-link device. Correspondingly, the first multi-link device may receive the fourth message from the second multi-link device.

For example, the fourth message may indicate that the second multi-link device does not accept the first message, and/or that the first message is different from the second message, and/or that the negotiation fails. In other words, the fourth message may explicitly indicate that the negotiation fails.

In some embodiments, after the first multi-link device receives the second message from the second multi-link device in S807, the first multi-link device may perform the following S808.

In some other embodiments, after the second multi-link device sends the second message to the first multi-link device in S807, the second multi-link device performs S803.

In other words, after the second multi-link device sends the second message to the first multi-link device, to indicate that the second message is different from the first message, the second multi-link device may use the second message as the first message, and directly determine, based on the second message, to transmit data with the first multi-link device in the duplication transmission mode or the non-duplication transmission mode. The second multi-link device no longer negotiates transmission modes for the second multi-link device to send different types of data.

S808: The first multi-link device sends a fifth message to the second multi-link device. Correspondingly, the second multi-link device receives the fifth message from the first multi-link device.

The fifth message may be determined based on the second message, and the fifth message may indicate transmission modes for the second multi-link device to send different types of data.

In other words, after the negotiation between the first multi-link device and the second multi-link device fails, the first multi-link device may re-generate a message indicating transmission modes for the second multi-link device to send different types of data, and send the message to the second multi-link device, to re-negotiate with the second multi-link device about the transmission modes for the second multi-link device to send different types of data.

Optionally, if the first multi-link device determines that a quantity of times of consecutively receiving the second message, a quantity of times of consecutively receiving the fourth message, or a quantity of times of consecutively generating the fifth message is greater than a first negotiation threshold, the first multi-link device stops determining the fifth message.

For example, the first negotiation threshold may indicate a maximum quantity of consecutive negotiation failures between the first multi-link device and the second multi-link device.

In other words, if the quantity of negotiation failures between the first multi-link device and the second multi-link device is greater than the first negotiation threshold, the first multi-link device stops negotiating with the second multi-link device.

Optionally, if the second multi-link device determines that a quantity of times of consecutively sending the second message, a quantity of times of consecutively sending the fourth message, or a quantity of times of consecutively receiving the fifth message is greater than the first negotiation threshold, the second multi-link device uses the second message as the first message, or uses the fifth message as the first message, and performs S803.

In other words, if the quantity of negotiation failures between the first multi-link device and the second multi-link device is greater than the first negotiation threshold, the second multi-link device may determine, based on the second message determined by the second multi-link device, to send data to the first multi-link device in the duplication transmission mode or the non-duplication transmission mode. Alternatively, the second multi-link device may determine, based on the fifth message or the first message sent by the first multi-link device, to send data to the first multi-link device in the duplication transmission mode or the non-duplication transmission mode, and stop performing negotiation again. This reduces power consumption and improves a data transmission rate.

According to the communication method in FIG. 8, the second multi-link device determines, based on the first message that is sent by the first multi-link device and that indicates the transmission modes for the second multi-link device to send different types of data, to send the data to the first multi-link device in the duplication transmission mode or the non-duplication transmission mode. In this way, the different types of data can be transmitted in corresponding transmission modes, and multiple links between the first multi-link device and the second multi-link device are properly used, to improve data transmission efficiency while ensuring reliability.

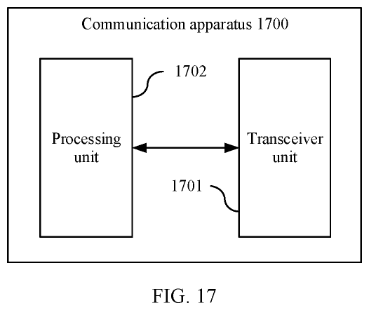

The foregoing describes in detail the communication methods provided in embodiments of this application with reference to FIG. 8 to FIG. 16. The following describes in detail a communication apparatus provided in an embodiment of this application with reference to FIG. 17.

FIG. 17 is a schematic diagram 2 of a structure of a communication apparatus according to an embodiment of this application. As shown in FIG. 17, the communication apparatus 1700 includes a transceiver unit (e.g., transceiver circuit) 1701 and a processing unit (e.g., processing circuit) 1702. For ease of description, FIG. 17 shows only main components of the communication apparatus.

In a possible design solution, the communication apparatus 1700 shown in FIG. 17 may be applied to the communication system shown in FIG. 1, to perform a function of the first multi-link device in the communication method in FIG. 8.

The transceiver unit 1701 is configured to receive a first message from a first multi-link device, where the first message indicates transmission modes for the communication apparatus 1700 to send different types of data, and the transmission modes include a duplication transmission mode and a non-duplication transmission mode.

The processing unit 1702 is configured to determine, based on the first message, to send data to the first multi-link device in the duplication transmission mode or the non-duplication transmission mode.

In a possible design solution, the transceiver unit 1701 is further configured to send a second message to the first multi-link device, where the second message is determined based on the first message, and the second message indicates transmission modes for the communication apparatus 1700 to send different types of data.

In a possible design solution, the first message may include transmission mode information of at least one piece of TID type data.

In a possible design solution, the first message may include transmission mode information of at least one piece of TID type data corresponding to at least one link.

In a possible design solution, the first message may include transmission mode information of at least one piece of TS type data.

In a possible design solution, in a possible design solution, the first message may include transmission mode information of at least one piece of TS type data corresponding to at least one link.

In a possible design solution, the first message may include one or more of a transmission delay threshold, a transmission packet loss rate threshold, or a buffer size threshold of at least one piece of TID type data.

In a possible design, the first message may include one or more of a transmission delay threshold, a transmission packet loss rate threshold, or a buffer size threshold of at least one piece of TID type data corresponding to at least one link.

In a possible design, the first message may include one or more of a transmission delay threshold, a transmission packet loss rate threshold, or a buffer size threshold of at least one piece of TS type data.

In a possible design solution, the first message may include one or more of a transmission delay threshold, a transmission packet loss rate threshold, or a buffer size threshold of at least one piece of TS type data corresponding to at least one link.

Optionally, the first message may include at least one communication apparatus 1700 identifier.

In a possible design solution, the processing unit 1702 is further configured to: if a first condition is met, determine to send data to the first multi-link device in the duplication transmission mode, where the first condition may include: a transmission delay of the TID type data is greater than the transmission delay threshold of the TID type data, or a transmission packet loss rate of the TID type data is greater than the transmission packet loss rate threshold of the TID type data, or a buffer size of the TID type data is greater than the buffer size threshold of the TID type data.

In a possible design solution, the processing unit 1702 is further configured to: if a second condition is met, determine to send data to the first multi-link device in the duplication transmission mode, where the second condition may include: a transmission delay of the TID type data corresponding to the link is greater than the transmission delay threshold of the TID type data corresponding to the link, or a transmission packet loss rate of the TID type data corresponding to the link is greater than the transmission packet loss rate threshold of the TID type data corresponding to the link, or a buffer size of the TID type data corresponding to the link is greater than the buffer size threshold of the TID type data corresponding to the link.

In a possible design solution, the processing unit 1702 is further configured to: if a third condition is met, determine to send data to the first multi-link device in the duplication transmission mode, where the third condition may include: a transmission delay of the TS type data is greater than the transmission delay threshold of the TS type data, or a transmission packet loss rate of the TS type data is greater than the transmission packet loss rate threshold of the TS type data, or a buffer size of the TS type data is greater than the buffer size threshold of the TS type data.

In a possible design solution, the processing unit 1702 is further configured to: if a fourth condition is met, determine to send data to the first multi-link device in the duplication transmission mode, where the fourth condition may include: a transmission delay of the TS type data corresponding to the link is greater than the transmission delay threshold of the TS type data corresponding to the link, or a transmission packet loss rate of the TS type data corresponding to the link is greater than the transmission packet loss rate threshold of the TS type data corresponding to the link, or a buffer size of the TS type data corresponding to the link is greater than the buffer size threshold of the TS type data corresponding to the link.

Optionally, the duplication transmission mode may be transmitting same data over at least two links. The duplication transmission mode may include a synchronous duplication transmission mode and an asynchronous duplication transmission mode. The synchronous duplication transmission mode may be simultaneously transmitting same data over the at least two links. The asynchronous duplication transmission mode may be transmitting same data over the at least two links at different times.

Optionally, the non-duplication transmission may be transmitting different data over a first link and a second link. The non-duplication transmission mode may include a synchronous non-duplication transmission mode and an asynchronous non-duplication transmission mode. The synchronous non-duplication transmission mode may be simultaneously transmitting different data over the first link and the second link. The asynchronous non-duplication transmission mode may be transmitting different data over the first link and the second link at different times, the second link is a link other than the first link between the communication apparatus 1700 and a second multi-link device.

It should be noted that the transceiver unit 1701 may include a receiving unit (e.g., receiving sub-circuit) and a sending unit (e.g., sending sub-circuit) (not shown in FIG. 17). The receiving unit is configured to receive data and/or signaling from the second multi-link device. The sending unit is configured to send data and/or signaling to the second multi-link device. An implementation of the transceiver unit 1701 is not specifically limited in this application.

Optionally, the communication apparatus 1700 may further include a storage module (not shown in FIG. 17). The storage module stores a program or instructions. When the processing unit executes the program or the instructions, the communication apparatus 1700 is enabled to perform a function of the first multi-link device in the communication method in FIG. 8.

It should be noted that, the communication apparatus 1700 may be the first multi-link device 101 shown in FIG. 1, the AP multi-link device or the STA multi-link device shown in FIG. 2, the AP multi-link device or the STA multi-link device shown in FIG. 3, the AP multi-link device or the STA multi-link device shown in FIG. 4, the AP multi-link device 501 or the STA multi-link device 502 shown in FIG. 5, or the AP multi-link device 601, the STA multi-link device 602, or the STA multi-link device 603 shown in FIG. 6, or the communication apparatus 700 shown in FIG. 7, or may be a chip (e.g., system) or another part or component that may be disposed in the first multi-link device. This is not limited in this application.

In addition, for a technical effect of the communication apparatus 1700, refer to the technical effect of the communication method in FIG. 8. Details are not described herein again.

In another possible design solution, the communication apparatus 1700 shown in FIG. 17 may be applied to the communication system shown in FIG. 1, to perform a function of the second multi-link device in the communication method in FIG. 8.

The processing unit 1702 is configured to generate a first message. The first message indicates transmission modes for a second multi-link device to send different types of data, and the transmission modes include a duplication transmission mode and a non-duplication transmission mode.

The transceiver unit 1701 is configured to send the first message to the second multi-link device.

In a possible design solution, the transceiver unit 1701 is further configured to receive a second message from the second multi-link device, where the second message may be determined based on the first message, and the second message may indicate transmission modes for the second multi-link device to send different types of data.

In a possible design solution, the first message may include transmission mode information of at least one piece of TID type data.

In a possible design solution, the first message may include transmission mode information of at least one piece of TID type data corresponding to at least one link.

In a possible design solution, the first message may include transmission mode information of at least one piece of TS type data.

In a possible design solution, in a possible design solution, the first message may include transmission mode information of at least one piece of TS type data corresponding to at least one link.

In a possible design solution, the first message may include one or more of a transmission delay threshold, a transmission packet loss rate threshold, or a buffer size threshold of at least one piece of TID type data.

In a possible design, the first message may include one or more of a transmission delay threshold, a transmission packet loss rate threshold, or a buffer size threshold of at least one piece of TID type data corresponding to at least one link.

In a possible design, the first message may include one or more of a transmission delay threshold, a transmission packet loss rate threshold, or a buffer size threshold of at least one piece of TS type data.

In a possible design solution, the first message may include one or more of a transmission delay threshold, a transmission packet loss rate threshold, or a buffer size threshold of at least one piece of TS type data corresponding to at least one link.

Optionally, the first message may include at least one second multi-link device identifier.

In a possible design solution, the processing unit 1702 is further configured to: if a first condition is met, indicate to transmit the TID type data in the duplication transmission mode, where the first condition may include: a transmission delay of the TID type data is greater than the transmission delay threshold of the TID type data, or a transmission packet loss rate of the TID type data is greater than the transmission packet loss rate threshold of the TID type data, or a buffer size of the TID type data is greater than the buffer size threshold of the TID type data.

In another possible design solution, the processing unit 1702 is further configured to: if a second condition is met, indicate to transmit the TID type data corresponding to the link in the duplication transmission mode, where the second condition may include: a transmission delay of the TID type data corresponding to the link is greater than the transmission delay threshold of the TID type data corresponding to the link, or a transmission packet loss rate of the TID type data corresponding to the link is greater than the transmission packet loss rate threshold of the TID type data corresponding to the link, or a buffer size of the TID type data corresponding to the link is greater than the buffer size threshold of the TID type data corresponding to the link.

In a possible design solution, the processing unit 1702 is further configured to: if a third condition is met, indicate to transmit the TS type data in the duplication transmission mode. The third condition may include: a transmission delay of the TS type data is greater than the transmission delay threshold of the TS type data, or a transmission packet loss rate of the TS type data is greater than the transmission packet loss rate threshold of the TS type data, or a buffer size of the TS type data is greater than the buffer size threshold of the TS type data.

In a possible design solution, the processing unit 1702 is further configured to: if a fourth condition is met, indicate to transmit the TS type data corresponding to the link in the duplication transmission mode. The fourth condition may include: a transmission delay of the TS type data corresponding to the link is greater than the transmission delay threshold of the TS type data corresponding to the link, or a transmission packet loss rate of the TS type data corresponding to the link is greater than the transmission packet loss rate threshold of the TS type data corresponding to the link, or a buffer size of the TS type data corresponding to the link is greater than the buffer size threshold of the TS type data corresponding to the link.

Optionally, the duplication transmission mode may be transmitting same data over at least two links. The duplication transmission mode may include a synchronous duplication transmission mode and an asynchronous duplication transmission mode. The synchronous duplication transmission mode may be simultaneously transmitting the same data over the at least two links. The asynchronous duplication transmission mode may be transmitting same data over the at least two links at different times.

Optionally, the non-duplication transmission may be transmitting different data over a first link and a second link. The non-duplication transmission mode may include a synchronous non-duplication transmission mode and an asynchronous non-duplication transmission mode. The synchronous non-duplication transmission mode may be simultaneously transmitting different data over the first link and the second link. The asynchronous non-duplication transmission mode may be transmitting the different data over the first link and the second link at different times, the second link is a link other than the first link between a first multi-link device and the communication apparatus 1700.

It should be noted that the transceiver unit 1701 may include a receiving unit and a sending unit (not shown in FIG. 17). The receiving unit is configured to receive data and/or signaling from the first multi-link device. The sending unit is configured to send data and/or signaling to the first multi-link device. An implementation of the transceiver unit 1701 is not limited in this application.

Optionally, the communication apparatus 1700 may further include a storage module (not shown in FIG. 17). The storage module stores a program or instructions. When the processing unit executes the program or the instructions, the communication apparatus 1700 is enabled to perform a function of the second multi-link device in the communication method in FIG. 8.

It should be noted that, the communication apparatus 1700 may be the first multi-link device 101 shown in FIG. 1, the AP multi-link device or the STA multi-link device shown in FIG. 2, the AP multi-link device or the STA multi-link device shown in FIG. 3, the AP multi-link device or the STA multi-link device shown in FIG. 4, the AP multi-link device 501 or the STA multi-link device 502 shown in FIG. 5, or the AP multi-link device 601, the STA multi-link device 602, or the STA multi-link device 603 shown in FIG. 6, or the communication apparatus 700 shown in FIG. 7, or may be a chip (e.g., system) or another part or component that may be disposed in the second multi-link device. This is not limited in this application.

In addition, for a technical effect of the communication apparatus 1700, refer to the technical effect of the communication method in FIG. 8. Details are not described herein again.

An embodiment of this application provides a communication system. The system includes a first multi-link device and one or more second multi-link devices.

An embodiment of this application provides a computer-readable storage medium. The computer-readable storage medium includes a computer program or instructions. When the computer program or the instructions are run on a computer, the computer is enabled to perform the communication method in the foregoing method embodiments.

An embodiment of this application provides a computer program product, including a computer program or instructions. When the computer program or the instructions are run on a computer, the computer is enabled to perform the communication method in the foregoing method embodiments.

It should be understood that, the processor in embodiments of this application may be a CPU, or may be another general-purpose processor, a DSP, an ASIC, a FPGA or another programmable logic device (PLC), a discrete gate or a transistor logic device, a discrete hardware component, or the like. The general-purpose processor may be a microprocessor, or the processor may be any conventional processor or the like.

It may be understood that the memory in embodiments of this application may be a volatile memory or a nonvolatile memory, or may include a volatile memory and a nonvolatile memory. The nonvolatile memory may be a ROM, a programmable read-only memory (PROM, an erasable programmable read-only memory (EPROM, an EEPROM, or a flash memory. The volatile memory may be a RAM, used as an external cache. Through an example rather than a limitative description, RAM in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented using software, hardware (for example, circuitry), firmware, or any combination thereof. When software is used to implement embodiments, the foregoing embodiments may be implemented completely or partially in a form of a computer program product. The computer program product includes one or more computer instructions or computer programs. When the computer instructions or the computer programs are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive (SSD).

It should be understood that the term “and/or” in this specification describes only an association relationship between associated objects, and indicates that there may be three relationships. For example, A and/or B may indicate the following three cases: Only A exists, both A and B exist, and only B exists. A and B may be singular or plural. In addition, the character “I” in this specification usually indicates an “or” relationship between associated objects, or may indicate an “and/or” relationship. A specific meaning depends on the context.

In this application, at least one means one or more, and multiple means two or more. At least one of the following items (e.g., pieces) or a similar expression thereof refers to any combination of these items, including any combination of singular items (e.g., pieces) or plural items (e.g., pieces). For example, at least one of a, b, or c may indicate: a, b, c, a-b, a-c, b-c, or a-b-c, where a, b, and c may be singular or plural.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that, in combination with the examples described in embodiments disclosed in this specification, units or modules, and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit or module, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units or modules is merely logical function division, or may be other division during actual implementation. For example, multiple units or modules may be combined or integrated into another system, some units or modules may be ignored, or functions corresponding some units or modules are not performed. In addition, the displayed or discussed mutual couplings or direct couplings or communication connections may be implemented through some interfaces. The indirect couplings or communication connections between the apparatuses or units/modules may be implemented in electrical, mechanical, or other forms.

The units/modules described as separate parts may or may not be physically separate, and parts displayed as units/modules may or may not be physical units/modules, may be located in one position, or may be distributed on multiple network units/modules. Some or a part of the units/modules may be selected based on actual requirements to achieve the objectives of the solutions of embodiments.

In addition, the functional units/modules in embodiments of this application may be integrated into one processing unit/module, each of the units/modules may exist alone physically, or two or more units/modules are integrated into one unit/module.

When the functions are implemented in a form of a software functional unit/module and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a universal serial bus (USB) flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication apparatus, applied to a second multi-link device, comprising:
at least one processor, and a memory storing instructions for execution by the at least one processor;
wherein, when executed, the instructions cause the second multi-link device to perform operations comprising:
receiving a first message from a first multi-link device, wherein the first message indicates transmission modes for the apparatus to send different types of data, and the transmission modes comprise a duplication transmission mode and a non-duplication transmission mode; and
determining based on the first message, to send data to the first multi-link device in the duplication transmission mode or the non-duplication transmission mode.

2. The communication apparatus according to claim 1, wherein the operations further comprise:
sending, a second message to the first multi-link device, wherein the second message is determined based on the first message, and the second message indicates transmission modes for the apparatus to send different types of data.

3. The communication apparatus according to claim 1, wherein the first message comprises transmission mode information of at least one piece of traffic identifier (TID) type data.

4. The communication apparatus according to claim 1, wherein the first message comprises transmission mode information of at least one piece of traffic identifier (TID) type data corresponding to at least one link.

5. The communication apparatus according to claim 1, wherein the first message comprises transmission mode information of at least one piece of traffic stream (TS) type data.

6. The communication apparatus according to claim 1, wherein the first message comprises transmission mode information of at least one piece of traffic stream (TS) type data corresponding to at least one link.

7. The communication apparatus according to claim 1, wherein the first message comprises one or more of a transmission delay threshold, a transmission packet loss rate threshold, or a buffer size threshold of at least one piece of traffic identifier (TID) type data.

8. The communication apparatus according to claim 1, wherein the first message comprises one or more of a transmission delay threshold, a transmission packet loss rate threshold, or a buffer size threshold of at least one piece of traffic identifier (TID) type data corresponding to at least one link.

9. The communication apparatus according to claim 1, wherein the first message comprises one or more of a transmission delay threshold, a transmission packet loss rate threshold, or a buffer size threshold of at least one piece of traffic stream (TS) type data.

10. The communication apparatus according to claim 1, wherein the first message comprises one or more of a transmission delay threshold, a transmission packet loss rate threshold, or a buffer size threshold of at least one piece of traffic stream (TS) type data corresponding to at least one link.

11. A communication apparatus, applied to a first multi-link device, comprising:
at least one processor, and a memory storing instructions for execution by the at least one processor;
wherein, when executed, the instructions cause the first multi-link device to perform operations comprising:
generating, a first message, wherein the first message indicates transmission modes for a second multi-link device to send different types of data, and the transmission modes comprise a duplication transmission mode and a non-duplication transmission mode; and
sending, the first message to the second multi-link device.

12. The communication apparatus according to claim 11, wherein the operations further comprise:
receiving, a second message from the second multi-link device, wherein the second message is determined based on the first message, and the second message indicates transmission modes for the second multi-link device to send different types of data.

13. The communication apparatus according to claim 11, wherein the first message comprises transmission mode information of at least one piece of traffic identifier (TID) type data.

14. The communication apparatus according to claim 11, wherein the first message comprises transmission mode information of at least one piece of traffic identifier (TID) type data corresponding to at least one link.

15. The communication apparatus according to claim 11, wherein the first message comprises transmission mode information of at least one piece of traffic stream (TS) type data.

16. The communication apparatus according to claim 11, wherein the first message comprises transmission mode information of at least one piece of traffic stream (TS) type data corresponding to at least one link.

17. The communication apparatus according to claim 11, wherein the first message comprises one or more of a transmission delay threshold, a transmission packet loss rate threshold, or a buffer size threshold of at least one piece of traffic identifier (TID) type data.

18. The communication apparatus according to claim 11, wherein the first message comprises one or more of a transmission delay threshold, a transmission packet loss rate threshold, or a buffer size threshold of at least one piece of traffic identifier (TID) type data corresponding to at least one link.

19. The communication apparatus according to claim 11, wherein the first message comprises one or more of a transmission delay threshold, a transmission packet loss rate threshold, or a buffer size threshold of at least one piece of traffic stream (TS) type data.

20. The communication apparatus according to claim 11, wherein the first message comprises one or more of a transmission delay threshold, a transmission packet loss rate threshold, or a buffer size threshold of at least one piece of traffic stream (TS) type data corresponding to at least one link.
